(19) United States
(12) Patent Application Publication
(10) Pub. No.: US 2006/0280051 A1
(43) Pub. Date: Dec. 14, 2006

(54) Handheld audio player with equalizer

(76) Inventor: Michael Petrella, West Hartford, CT (US)

Correspondence Address: CANTOR COLBURN, LLP, 55 GRIFFIN ROAD SOUTH, BLOOMFIELD, CT, 06002, US

(21) Appl. No.: 11/135,795

(22) Filed: May 24, 2005

(51) Int. Cl. G11B 7/085

(52) U.S. Cl. 369/30.6

(57) ABSTRACT

A handheld audio player configured to alter the relative amplitude of a selected frequency band or plurality of frequency bands of an audio playback generated by the audio player, the audio player including a housing, a control for operating the audio player and an interface, the interface configured to be manually manipulated by a user to affect the altering of the relative amplitude, such interface being a slider bar.

### BACKGROUND OF INVENTION

(a) Field of Invention

The present invention relates generally to audio devices. More specifically, the invention relates to handheld audio players with an interface that is manually adjusted by a user to alter the relative amplitude of a selected frequency or a plurality of frequencies of an audio playback generated by the audio player.

(b) Description of Related Art

A variety of portable audio players are well known in the art. Such players include compact disc players and digital audio players. Generally, these devices are lightweight and battery powered so that they may be carried and transported by a user to an outdoor or remote location. Commonly, the user may use headphones or other earpieces to listen to the audio playback of the audio player.

The use of audio data players capable of playing digitally encoded audio data are also well known. In particular, relatively small handheld devices that can process digitally encoded audio data stored on memory medium have become popular. In an audio data player, the digital audio data previously downloaded, such as to a personal computer (PC) from an audio compact disc (CD), is loaded into the data storage device associated with the audio player. The audio data is further processed for reproduction. Such processing includes those such as MP3.

Most audio players utilize a digital signal processor (DSP) for processing the audio data, including selection of preset genres and transformations of the audio data source file store in the data storage device associated with the audio player.

Particularly with digital audio players, the sound quality may be relatively high, but the ability for a user to change and customize the frequencies of the music being listened to is relatively limited. In cases such as an MP3 player, the user is often forced to accept the preset frequency setting based on the genre of music they choose to listen to. Effectively, the user is left to simply listen to the audio playback through the headphones or earpieces.

The operation of those players that allow some user input to the sound are often require multiple controls, possibly interacting with a display and executing numerous commands to finally affect the sound of an audio playback. These cumbersome and often confusing methods of changing the audio playback are not user friendly or convenient, especially when the handheld player is being used during remote activities, such as walking or running.

In a variety of applications, interactivity may increase user enjoyment from electronic devices. It is believed that involving the user in their entertainment enhances the experience of many entertainment forms to the user.

Therefore, an apparatus is desired that provides the ability for a user to customize the sound of audio playback generated by a handheld audio player in a simple and straightforward manner, such as through adjusting the relative amplitude of a selected frequency or a plurality of frequencies of the audio playback through manually manipulating an interface, thereby affecting the sound of the audio playback.

### SUMMARY OF INVENTION

In an exemplary embodiment, the invention, which will described subsequently in greater detail, provides a handheld audio player configured to alter relative amplitude of a selected frequency band or plurality of frequency bands of an audio playback generated by the audio player, the audio player including a housing, a control for operating the audio player and an interface configured to be manually manipulated by a user to affect the altering of the relative amplitude, the interface being a slider bar.

In another exemplary embodiment, the handheld audio player is at least one of an MP3 player, a digital audio player, a compact disc player, a cassette type player, a mini-disc player, a digital audio tape player or a portable radio receiver.

In another exemplary embodiment, the handheld audio player is configured to provide the function of a graphic equalizer.

In another exemplary embodiment, a method of customizing audio playback of an audio program includes operating a control on a handheld audio player, manually manipulating an interface to alter the relative amplitude of a selected frequency band or plurality of frequency bands of the audio playback, the interface being a slider bar, and affecting the audio playback generated in response to manipulating the interface.

### BRIEF DESCRIPTION OF THE DRAWINGS

Referring now to the drawings wherein like elements are numbered alike in the several FIGURES:

FIG. 1 is a perspective view of a handheld audio player in accordance with an exemplary embodiment; and

FIG. 2 is a flowchart of the operation of the exemplary embodiment of FIG. 1.

### DETAILED DESCRIPTION OF THE INVENTION

Before explaining at least one embodiment of the invention in detail, it is to be understood that the invention is not limited in is application to the details of construction and to the arrangements of the components set forth in the following description or illustrated in the drawings. The invention is capable of other embodiments and of being practiced and carried out in various ways. The terms “a” and “an” herein to not denote a limitation of quantity, but rather denote the presence of at least one of the referenced item.

As such, those skilled in the art will appreciate that the conception, upon which this disclosure is based, may be readily utilized as a basis for the designing of other structures, methods and systems for carrying out the several purposes of the present invention. It is important, therefore, that the claims be regarded as including such equivalent constructions insofar as they do not depart from the spirit and scope of the present invention. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

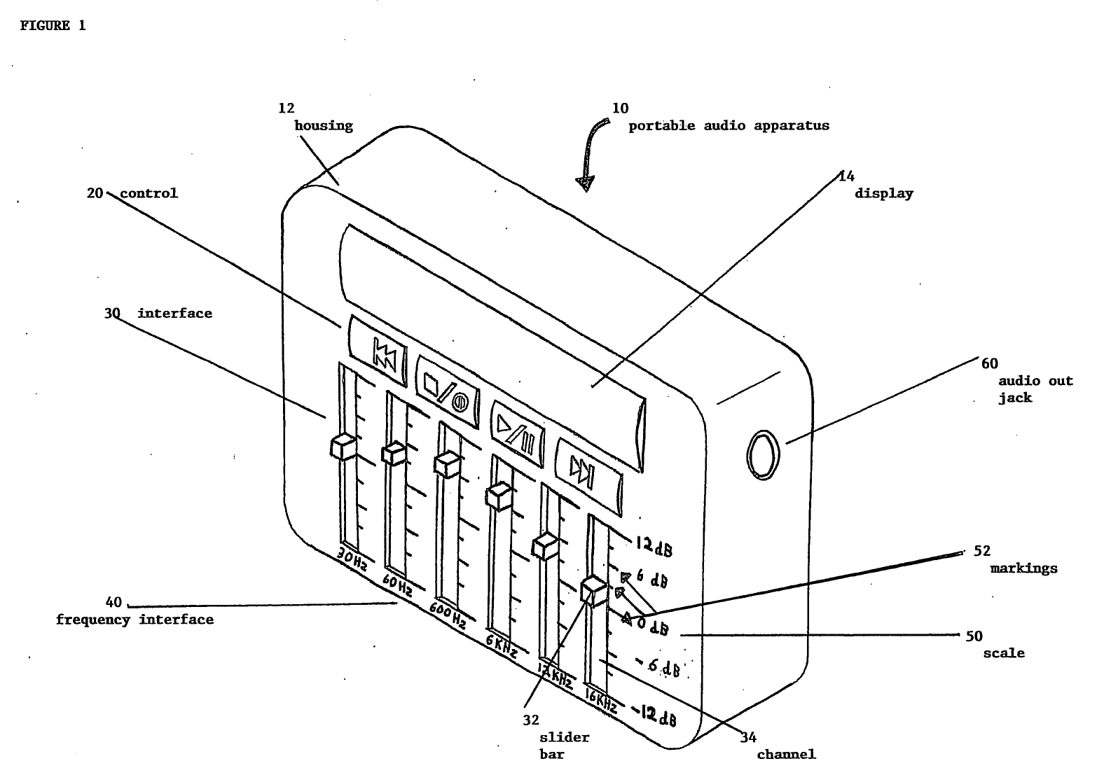

FIG. 1 shows a view of an audio player 10 in one exemplary embodiment of the invention. The audio player 10 may include, but is not limited to a housing 12, the housing 12 having a display 14 for displaying various information to a user, a control 20 for operating the portable audio player 10, an interface 30 for altering relative amplitude of a selected frequency of an audio playback of the audio player 10 and an audio out jack 60 for connecting an audio output device (not shown). The audio player 10 may be an MP3 player, a digital audio player, a compact disc player, a cassette type player, a mini-disc player, a digital audio tape player, a radio or the like, or any device that is capable of providing audio playback of an audio program selected by the user, as well as combinations including at least one of the foregoing. The audio player 10 is battery-powered, but may be powered in another way including, but not limited to, an electrical cord or cable.

The housing 12 of the audio player 10 may be approximately palm sized to fit in the user's hand, a garment pocket or otherwise conveniently worn by the user. The housing 12 may be sized in any manner permitting the audio player 10 to be easily transported by the user between locations, these locations usually outside or remote from fixed power sources.

FIG. 1 shows the generally rectangular display 14 located proximate to one side, which may be considered the top, of the handheld audio player 10. The display 14 extends in large proportion to the length of the housing 12, but not necessarily so. The display 14 has a type of a three-dimensional profile that slightly protrudes from the housing 12. It is contemplated that the display 14 may be of any profile, size, shape or configuration, or located at any place on any side of the housing 12 as is convenient for the design of the audio player 10. It should be evident that other elements characterizing the display 14 of the audio player 10 are well known and need not be addressed further.

The control 20 disposed on the housing 12 allows the user to operate the audio player 10. The control 20 can be any of a number of configurations, including but not limited to a display screen or touch screen hot spot, and manual operators such as pushbuttons, knobs, dials and the like, as well as combinations including at least one of the foregoing. FIG. 1 shows the control 20 as a rectangular pushbutton located under the display 14. In this particular embodiment, multiple controls 20 are disposed in a row under of the display 14, all roughly evenly distributed and of the same size, while not necessarily so. The control 20 may be located at any place on any side of the housing 12 and may be of any shape or size as is convenient for the design of the audio player 10. For example, the control 20 may be located on the housing 12 so that when the user holds the audio player 10 in a hand, a thumb may be positioned over the control 20 to easily use the control 20. Alternatively, the audio player 10 may be held in one hand and operated using another hand.

The control 20 if FIG. 1 has a graphical character on the face of the control 20 to indicate the function the pushbutton operates. Functions of the control button 20 include but are not limited to common functions of handheld audio players such as on/off, play, pause, stop, skip, repeat, volume and audio program source select. It should be evident that other functions of the handheld audio player 10 are well known and need not be addressed further. Each control 20 may operate one or more of the functions listed by way of example above. The control 20 may include graphical or alphanumeric characters disposed on or near the control 20 such that the user would be able to identify the appropriate button for the desired function of the handheld audio player 10.

In the exemplary embodiment, the audio player 10 is configured to provide the function of a graphic equalizer, such as an electronic equalizer that allows one to increase or decrease a fixed set of frequency ranges in an audio system. As shown in FIG. 1, the interface 30 is provided for altering the relative amplitude of a selected frequency or plurality of frequencies of the audio playback of the handheld audio player 10. The interface 30 is shown disposed generally perpendicular to the control 20 row and the display 14. The interface 30 may be located at any place on any side of the housing 12 and may be of any size as is convenient for the design of the audio player 10.

The interface 30 may include a frequency interface 40, a scale 50 and a slider bar 32. The frequency interface 40 may correspond to a frequency band, which is centered on a nominal frequency. For example, in FIG. 1, the frequency interface 40 is provided for each of a group of six nominal frequencies, the nominal frequencies ranging from 30 Hertz (Hz) to 16 kilohertz (kHz). Of course, the group of nominal frequencies may be larger or smaller in number and include any of a number of frequency bands and/or nominal frequencies.

Associated with the frequency interface 40 may be a scale 50 of relative signal amplitude within the frequency band. The scale 50 may further include any number of a marking 52 to indicate relative signal amplitude in the frequency band, where the amplitudes span a range. The scale 50 may include marking 52 at a center of the range corresponding to the nominal frequency. At this center, or the nominal frequency, the audio playback of the audio player 10 is not affected. The scale 50 may also include graphical or alphanumeric characters disposed on or near the scale 50, such as proximate to marking 52, enabling the user to identify the relative signal amplitude corresponding to a position on the scale 50.

For example, in FIG. 1, for each frequency interface 40, scale 50 is provided with marking 52 at each end of the scale 50, at the center and intermittently along the range of relative signal amplitude, while not necessarily so. “0 dB” is proximate to center marking 52 to indicate center of the frequency band, or the nominal frequency, while other conventions or characters may be used to define the same or other point on the frequency band. The relative signal amplitude ranges from −12 decibels (dB) to +12 decibels (dB) in the exemplary embodiment, but other ranges are also envisioned.

The interface 30 is a slider bar 32, and may be provided for each frequency interface 40, while not necessarily so. The shape of the slider bar 32 may include rectilinear, partially hemispherical, partially spherical, cylindrical, or the like, as well as combinations including at least one of the foregoing. It is contemplated that the slider bar 32 may be configured in any of a number of ways, such as close to level with the housing 12 surface or slightly recessed in the housing 12, to allow the user to manually manipulate interface 30. Where more than one slider bar 32 is provided for the audio player 10, the slider bar 32 may be of a same or of a different shape from another slider bar 32.

In the exemplary embodiment of FIG. 1, slider bar 32 is provided for each frequency interface 40, corresponding to a frequency band. Here, slider bar 32 is shown as a three dimension rectilinear object that protrudes from the housing 12 surface. In use, the slider bar 32 of the embodiment in FIG. 1 would be easily manipulated by the user, due to the slider bar 32 protruding from the housing 12 surface, where the slider bar 32 could be conveniently handled by the user's finger.

To alter the relative amplitude within the frequency band of the playback, slider bar 32 may be manipulated by moving it along a corresponding channel 34 of the interface 30. For instance, in the exemplary embodiment of FIG. 1, the slider bar 32 of each frequency interface 40 has been moved along its corresponding channel 34 to various positions relative to the scale 50 of signal amplitude.

In some cases, such as with an MP3 player, there are preset frequency or equalization settings that will automatically affect the audio playback when the audio program is played. For instance, the preset settings are specific to audio genres such as classical, jazz, pop, rap and rock. In the case of preset frequency settings, handheld audio player 10 in the exemplary embodiment is configured to override the settings when the relative signal amplitude of the selected frequency band(s) is altered through manipulation of the interface 30,40 as described above.

The housing 12 may include an audio out jack 60, such as is illustrated in the exemplary embodiment of FIG. 1, for connecting to an external device (not shown). The audio out jack 60 may have a connector (not shown) to support the connection of the external device, such as by way of a cable. The external device may be removable so that the user could interchange multiple devices with the portable audio player 10, or it could be a non-removable external device. External devices include, but are not limited to, headphones, earphones/earplugs, speakers and the like.

In use, the handheld audio player 10 is a device that would allow the user to customize the sound of the audio playback generated by the audio player 10 in a simple and straightforward manner, specifically by altering the relative amplitude of a selected frequency or a plurality of frequencies of the audio playback through manually manipulating an interface, particularly a slider bar, thereby affecting the sound of the audio playback.

In another exemplary embodiment, a method of customizing audio playback of an audio program includes engaging a control 20 to operate a handheld audio player 10, manually manipulating an interface 30,40 to alter the relative amplitude of a selected frequency band or plurality of frequency bands of the playback generated by the audio player 10, the interface being a slider bar 32, and affecting the sound of the audio playback in response to manipulating the interface 30.

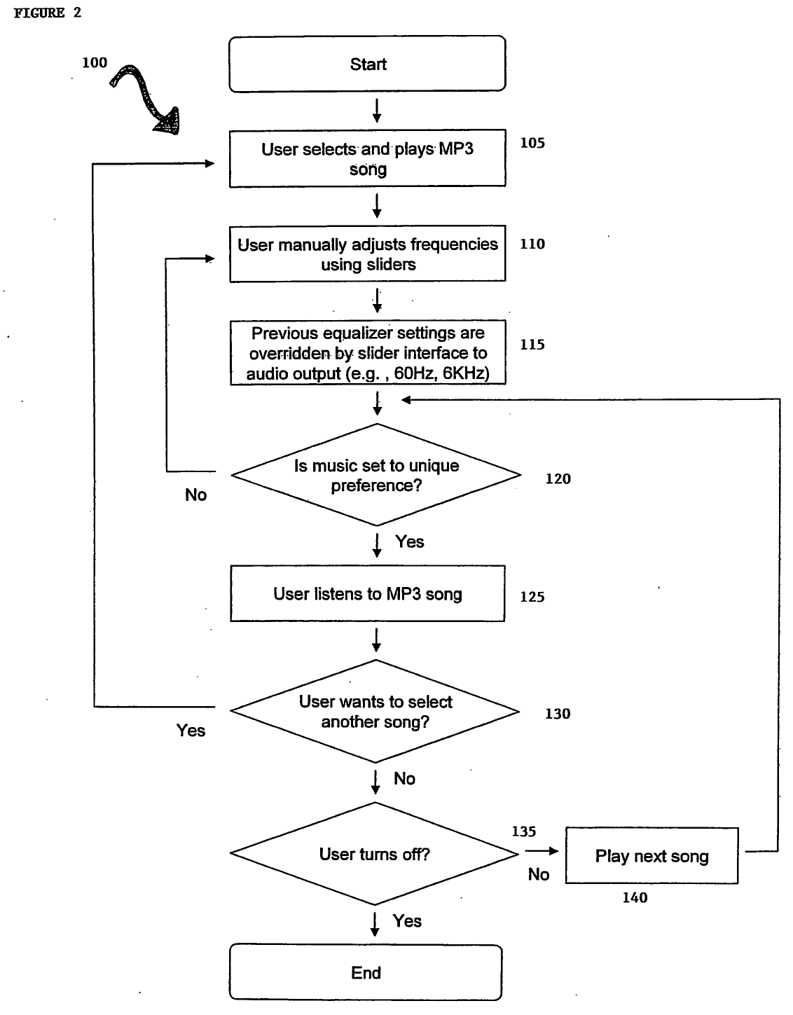

A flowchart 100 of the exemplary embodiment of customizing the sound of an audio playback of a handheld audio player, particularly an MP3 player, is illustrated in FIG. 2. The user selects and plays an MP3 song at block 105 by operating control 20. By manually manipulating slider bar 32 of interface 30,40 at block 110, the relative amplitude of the selected frequency band(s) of the audio playback generated by the audio player 10 is adjusted. Where there are preset frequency or equalizer settings, the altering of the relative signal amplitude of a frequency band by slider bar 32 of interface 30,40 overrides those preset settings at block 115. The user decides if the audio playback of the audio program, or music, is set to their preference at diamond 120. If the desired audio playback has not be achieved, the slider bar 32 of interface 30,40 is manually manipulated, as in block 110, to further alter the relative signal amplitude of the frequency band for the audio playback until the desired sound is achieved.

Once the user is satisfied with the sound of the audio playback at diamond 120, listening to the playback of the audio program is continued at block 125 until the end of the audio program, or in the case of Flowchart 100, the song. At that point, the user may select another program at diamond 130, turn off the audio player 10 at diamond 135 or allow the player 10 to play the next audio program at block 140 via operating the appropriate audio player 10 control 20. By using the slider bar 32 of the interface 30,40, the user is able to easily and straightforwardly alter the relative signal amplitude of the frequency band(s) of the audio playback, without a cumbersome or confusing set of commands or keystrokes.

With respect to the above description, it is considered as illustrative only of the principles of the invention, and the optimum dimensional relationships for the parts of the invention, to include variations in size, materials, shape, form, function and manner of operation, assembly and use, are deemed readily apparent and obvious to one skilled in the art.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A handheld audio player, the audio player comprising:
a housing;
a control for operating the audio player, the audio player configured to alter the relative amplitude of a selected frequency band or plurality of frequency bands of an audio playback; and
an interface, said interface configured to be manually manipulated by a user to affect said altering;
wherein said interface is a slider bar.

2. The audio player of claim 1, wherein the audio player comprises at least one of an MP3 player, a digital audio player, a compact disc player, a cassette type player, a mini-disc player, a digital audio tape player or a portable radio receiver.

3. The audio player of claim 1, wherein said altering overrides preset frequency settings associated with the handheld audio player or said audio playback.

4. The audio player of claim 1, wherein the audio player is configured to provide function of a graphic equalizer.

5. The audio player of claim 4, wherein said interface includes a frequency interface for a frequency band, said frequency band centered on a nominal frequency.

6. The audio player of claim 5, wherein said nominal frequency is one of a number of frequencies, said frequencies including 30 Hertz (Hz), 60 Hz, 600 Hz, 6 kiloHertz (KHz), 12 KHz and 16 KHz.

7. The audio player of claim 5, wherein said frequency interface includes a scale of relative signal amplitudes, said scale including any of a number of a marking to indicate relative signal amplitude in a range, said scale including a marking at the center of the range corresponding to said nominal frequency.

8. The audio player of claim 7, wherein said range spans from about −12 decibels (dB) to about +12 decibels (dB).

9. A method of customizing audio playback of an audio program, the method comprising:
operating a control on a handheld audio player, said operating including selecting and playing the audio program;
manually manipulating an interface to alter the relative amplitude of a selected frequency band or plurality of frequency bands of the audio playback generated by the audio player, said interface being a slider bar; and
affecting the audio playback generated in response to said manipulating of said interface.

10. The method of claim 9, wherein said audio player comprises one of at least an MP3 player, a digital audio player, a compact disc player, a cassette type player, a mini-disc player, a digital audio tape player or a portable radio receiver.

11. The method of claim 9, wherein said altering overrides preset frequency settings associated with said handheld audio player or the audio playback.

12. The method of claim 9, further comprising configuring said audio player to provide the function of a graphic equalizer.

13. The method of claim 12, wherein said interface further comprises a frequency interface for a frequency band, said frequency band centered on a nominal frequency, said nominal frequency being one of a number of frequencies, said frequencies including 30 Hertz (Hz), 60 Hz, 600 Hz, 6 kiloHertz (KHz), 12 KHz and 16 KHz.

14. The method of claim 13, wherein said frequency interface includes a scale of relative signal amplitudes, said scale including any of a number of a marking to indicate relative signal amplitude in a range, said range including a marking corresponding to said nominal frequency, wherein the audio playback is not affected when said slider bar is manipulated to said marking corresponding to said nominal frequency.
